(19) United States
(12) Patent Application Publication
(10) Pub. No.: US 2017/0052899 A1
(43) Pub. Date: Feb. 23, 2017

(54) BUFFER CACHE DEVICE METHOD FOR MANAGING THE SAME AND APPLYING SYSTEM THEREOF

(71) Applicant: MACRONIX INTERNATIONAL CO., LTD., Hsinchu (TW)

(72) Inventors: Ye-Jyun Lin, New Taipei City (TW); Hsiang-Pang Li, Zhubei City (TW); Cheng-Yuan Wang, Taipei City (TW); Chia-Lin Yang, Taipei City (TW)

(21) Appl. No.: 14/828,587

(22) Filed: Aug. 18, 2015

(51) Int. Cl. G06F 12/08; G06F 3/06

(52) U.S. Cl. CPC G06F 12/0897; G06F 3/0604; G06F 3/0656; G06F 3/0685; G06F 2212/225

(57) ABSTRACT

A buffer cache device used to get at least one data from at least one application is provided, wherein the buffer cache device includes a first-level cache memory, a second-level cache memory and a controller. The first-level cache memory is used to receive and store the data. The second-level cache memory has a memory cell architecture different from that of the first-level cache memory. The controller is used to write the data stored in the first-level cache memory into the second-level cache memory.

### BACKGROUND

Technical Field

The disclosure relates in generally related to a buffer cache device, the method for managing the same and the application system thereof, and more particularly to a hybrid buffer cache device having multi-level cache memories, the method for managing the same and the application system thereof.

Description of the Related Art

Buffer cache is the technique of storing a copy of data temporarily in rapidly-accessible storage media local to the processing unit (PU) and separate from the bulk/main storage device to provide the PU a quick access without referring back to the bulk storage device when the data is frequently requested, so as to improve the response/execution time of the operation system.

Typically, a traditional buffer cache device applies a dynamic random access memory (DRAM) as the rapidly-accessible storage media. However, the DRAM is a volatile memory, data stored in the DRAM cache may loss when the power supply is removed, and the file system may enter an inconsistent state upon sudden system crashes. To this end, the frequent synchronous writes are generated to ensure the data being stored to the bulk storage device. However, this approach may deteriorated the system operation efficiency.

In order to alleviate the previous problems, recently researches propose using a phase change memory (PCM) as the buffer cache. PCM that has several advantages such as much higher speed and endurance than a flash memory is considered as one of the most promising technologies for next generation non-volatile memory. However, PCM has some disadvantages such as longer write latency and shorter lifetime than DRAM. Furthermore, PCM can only write a limited data bytes, such as at most 32 bytes, in parallel due to the write power limitation, this may prolong serious write latency compared to the DRAM buffer cache. It seems to not be a proper approach to use PCM as the sole storage media of a buffer cache device.

Therefore, there is a need of providing an improved buffer cache device, the method for managing the same and the application systems thereof to obviate the drawbacks encountered from the prior art.

### SUMMARY

One aspect of the present invention is to provide a buffer cache device that is used to get at least one data from at least one application, wherein the buffer cache device includes a first-level cache memory, a second-level cache memory and a controller. The first-level cache memory is used to receive and store the data. The second-level cache memory has a memory cell architecture different from that of the first-level cache memory. The controller is used to write the data stored in the first-level cache memory into the second-level cache memory.

In accordance with another aspect of the present invention, a method for controlling a buffer cache having a first-level cache memory and a second-level cache memory with a memory cell architecture different from that of the first-level cache memory, wherein the method includes steps as follows: At least one data is received and stored by the first-level cache memory from at least one application. The data is then written into the second-level cache memory.

In accordance with yet another aspect of the present invention, an embedded system is provided, wherein the embedded system includes a main storage device, a buffer cache device and a controller. The buffer cache device includes a first-level cache memory and a second-level cache memory. The first-level cache memory is used to get at least one data from at least one application and store the data therein. The second-level cache memory has a memory cell architecture different from that of the first-level cache memory. The controller is used to write the data stored in the first-level cache memory into the second-level cache memory, and then to write the data stored in the second-level cache memory into the main storage device.

In accordance with the aforementioned embodiments of the present invention, a hybrid buffer cache device having a plurality multi-level cache memories and the applying system thereof are provided, wherein the hybrid buffer cache device at least includes a first-level cache memory and a second-level cache memory having a memory cell architecture different from that of the first-level cache memory. At least one data getting from at least one application can be firstly stored in the first-level cache memory, and a hierarchical write-back process is then performed to write the data stored in the first-level cache memory into the second-level cache memory. Such that, the problems of file system inconsistency in a prior buffer cache device using DRAM as the sole storage media can be solved.

In some embodiments of present invention, a sub-dirty block management is further introduced to enhance the write accesses of PCM involved in the hybrid buffer cache device, whereby the write latency due to the write power limitation of PCM can be also alleviated. In addition, the performance of the embedded system may be improved by applying a least-recently activated (LRA) data replacement policies to the buffer cache operation.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a block diagram illustrating an embedded system 100 in accordance with one embodiment of the present invention;

FIG. 1′ is a block diagram illustrating an embedded system 100′ in accordance with another embodiment of the present invention;

FIG. 2 is a block diagram illustrating the cache operation of embedded system in accordance with one embodiment of the present invention;

FIG. 3 is a diagram illustrating the decision-making rule of the LRA policy in accordance with one embodiment of the present invention;

FIG. 4 is a diagram illustrating the background flush process in accordance with one embodiment of the present invention;

FIG. 5 is a histogram illustrating the simulated I/O response time of the Android smart phone with different applications, various buffer cache architectures and management policies; and

FIG. 6 is a histogram illustrating the simulated application execution time of the Android smart phone with different applications, various buffer cache architectures and management policies.

### DETAILED DESCRIPTION

The embodiments as illustrated below provide a buffer cache device, the method thereof for managing the same and the applying system thereof to solve the problems of file system inconsistency and write latency resulted from using either DRAM or PCM as the sole storage media in a buffer cache device. The present invention will now be described more specifically with reference to the following embodiments illustrating the structure and arrangements thereof.

It is to be noted that the following descriptions of preferred embodiments of this invention are presented herein for purpose of illustration and description only. It is not intended to be exhaustive or to be limited to the precise form disclosed. Also, it is also important to point out that there may be other features, elements, steps and parameters for implementing the embodiments of the present disclosure which are not specifically illustrated. Thus, the specification and the drawings are to be regard as an illustrative sense rather than a restrictive sense. Various modifications and similar arrangements may be provided by the persons skilled in the art within the spirit and scope of the present invention. In addition, the illustrations may not be necessarily be drawn to scale, and the identical elements of the embodiments are designated with the same reference numerals.

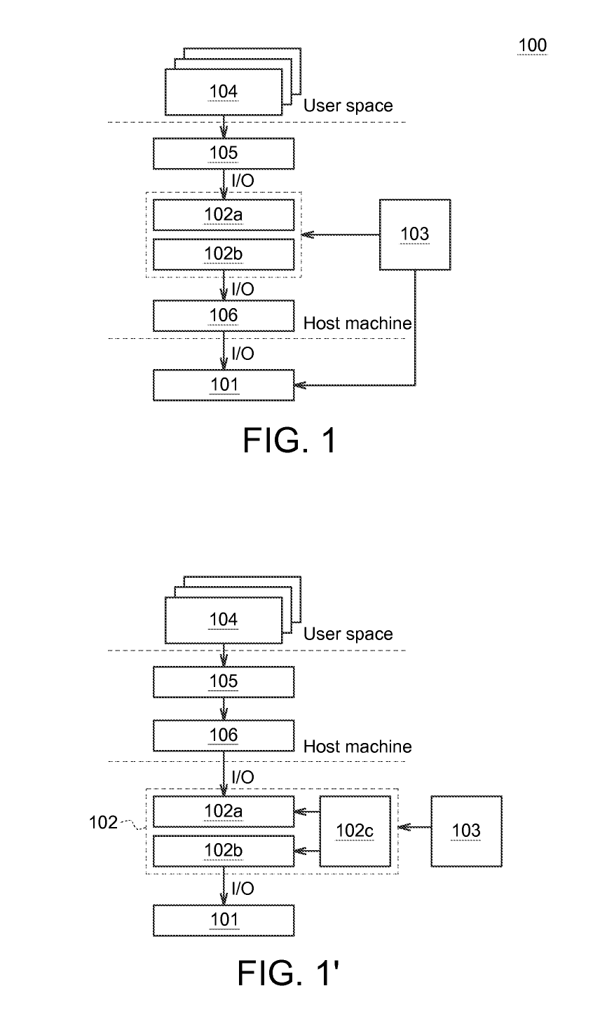

FIG. 1 is a block diagram illustrating an embedded system 100 in accordance with one embodiment of the present invention. The embedded system 100 includes a main storage device 101, a buffer cache device 102 and a controller 103. In some embodiments of the present, the main storage device 101 can be, but not limited to, a flash memory. In some other embodiments, the main storage device 101 can be a disk, an embedded multi-media card (eMMC), a solid state disk (SSD) or any other suitable storage media.

The buffer cache device 102 includes a first-level cache memory 102a and a second-level cache memory 102b, wherein the first-level cache memory 102a has a memory cell architecture different from that of the second-level cache memory 102b. In some embodiments of the present, the first-level cache memory 102a can be a DRAM; and the second-level cache memory 102b can be a PCM. However, in some other embodiment, this not limited in this respect. For example, the first-level cache memory 102a can be a PCM and the second-level cache memory 102b can be a DRAM.

In other words, as long as the first-level cache memory 102a and the second-level cache memory 102b have different memory cell architectures, in some embodiment of the present invention, the first-level cache memory 102a and the second-level cache memory 102b can be respectively selected from as group consisting of a spin transfer torque random access memory (STT-RAM), a magnetoresistive random access memory (MRAM), a resistive random access memory (ReRAM) and any other suitable storage media.

The controller 103 is used to get at least one data, such as an Input/Output (I/O) request of at least one application 105 provided from user space through a virtual file system (VFS)/file system, and store the I/O request in the first-level cache memory 102a. The controller 103 further provides a hierarchical write-back process to write the I/O request stored in the first-level cache memory 102a into the second-level cache memory 102b, and subsequently to write the I/O request stored in the second-level cache memory 102b into the main storage device 101 through a driver 106.

In some embodiments of the present invention, the controller 103 can be the PU of the embedded system 100 configured in the host machine (see FIG. 1). However, it is not limited in this respect. In some other embodiment, the controller 103 may be a control element 102c of the buffer cache device 102 built in the buffer cache device 102. FIG. 1′ is a block diagram illustrating an embedded system 100′ in accordance with another embodiment of the present invention. In the present embodiment, the cache operation of the I/O request is directly controlled by the control element 102c rather than the controller 103 configured in the host machine of the embedded system 100′

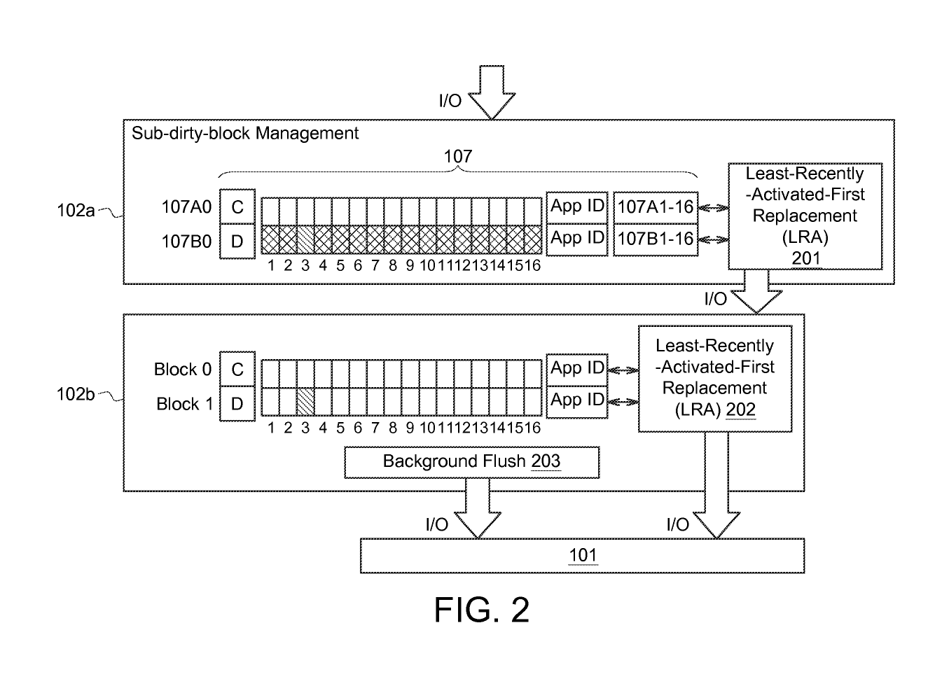

FIG. 2 is a block diagram illustrating the cache operation of the embedded system 100 in accordance with one embodiment of the present invention. In a preferred embodiment, the cache operation of the embedded system 100 is implemented by a hierarchical write-back process managed by the controller 103. The hierarchical write-back process includes following steps: (1) writing at least one dirty I/O request stored in the first-level cache memory 102a into the second-level cache memory 102b (shown as the arrow 201); (2) writing at least one dirty I/O request stored in the second-level cache memory 102b into the main storage device 101 (shown as the arrow 202); and (3) performing a background flush to Write at least one dirty I/O request stored in the second-level cache memory 102b into the main storage device 101 (shown as the arrow 203).

In some embodiments of the present invention, prior to the hierarchical write-back process the cache operation further includes a sub-block dirty management to arrange the data (such as the I/O request) store in the first-level cache memory 102a and the second-level cache memory 102b, wherein the sub-block dirty management includes steps as follows: Each of the memory blocks configured in the first-level cache memory 102a and the second-level cache memory 102b are firstly divided in to a plurality of sub-blocks, whereby each of the sub-blocks may contain a portion of the data stored in the first-level cache memory 102a and the second-level cache memory 102b. Each of the sub-blocks is then identified to determine whether or not the portion of the data stored therein is dirty.

Take the first-level cache memory 102a as an example, the first-level cache memory 102a has at least two blocks 107A and 107B; each blocks 107A (or 107B) is divided into 16 sub-blocks 1A-16A (or 1B-16B) for storing the I/O request, and each of the sub-blocks 1A-16A and 1B-16B has a granularity substantially equal to the maximum bits a PCM can write at a time (i.e. 32 bytes); and the block granularity of the blocks 107A and 107B is 512 bytes.

The blocks 107A (or 107B) further includes a dirty bit 107A0 (or 107B0), a plurality of sub-dirty bits 107A1-16 (or 107B1-16) and an application ID (APP ID) corresponding to the I/O requests store in the block 107A (or 107B). Each of the sub-dirty bits 107A1-16 (or 107B1-16) is corresponding to one of the sub-blocks 1A-16A (or 1B-16B) used to determine if there exists any dirty portion of the I/O request stored in the sub-blocks; and the sub-blocks that store the dirty portion of the I/O request are then identified as sub-dirty blocks by the corresponding sub-dirty bits. The dirty bit 107A0 and 107B0 are used to determine if there exists any sub-dirty block in the corresponding block 107A or 107B; and the block having at least one sub-dirty block is then identified as dirty block.

For example, in the present embodiment, the sub-dirty bits 107A1-16 and 107B1-16 respectively consist of 16 bites, and each one of the sub-dirty bits 107A1-16 and 107B1-16 is corresponding to one of the sub blocks 1A-16A and 1B-16B. The sub-block 3B is identified as a sub-dirty block by the sub-dirty bit 107B3 (designated by hatching delineated on the sub-block 3B). The block 107A that has no sub-dirty block is identified as clean designated by the alphabet “C”; and the block 107A that has the sub-dirty block 3B is identified as a dirty block designated by the alphabet “D”.

Subsequently, the dirty I/O request stored in the first-level cache memory 102a is then written into the second-level cache memory 102b (shown as the arrow 201). In the present embodiment, the dirty I/O request stored in the dirty block 107B can be written into the second-level cache memory 102b by merely writing the dirty portion of the I/O request stored in the sub-dirty block 3B, since merely the portion of the I/O request is dirty. In other words, by merely writing the portion of the I/O request stored in the sub-dirty block 3B, the entire dirty I/O request can be written into a non-volatile cache memory (PCM) from a volatile cache memory (DRAM).

In addition, since the granularity of the sub-dirty block 3B is substantially equal to the maximum bits the second-level cache memory 102b (PCM) can write at a time, thus the write latency can be avoid while the dirty I/O request stored in the dirty block 107B is written into the second-level cache memory 102b.

In the case when the first-level cache memory 102a has a plurality of dirty blocks, a replacement policy, such as a Least-Recently-Activated (LRA) policy, a CLOCK policy, a First-Come First-Served (FCFS) policy or a Least-Recently-Used (LRU) policy, can be chosen as the rule to decide the priority of the dirty blocks that will be written into the second-level cache memory 102b in accordance with the operation requirements of the embedded system 100. In some embodiments of the present invention, after the dirty blocks are written into the second-level cache memory 102b, the dirty blocks of the first-level cache memory 102a may be evicted to allow I/O requests subsequently received from other applications stored therein.

In the present embodiment, the LRA policy is applied to decide the priority of the dirty blocks that will be written into the second-level cache memory 102b. In this case, the rule of LRA policy is to choose the dirty I/O request least-recently being set as a foreground application as the first one to be written in to the second-level cache memory 102b, and then to evict the dirty block storing the chosen dirty I/O request. Wherein the foreground application is the application that is recently played on the display of an portable apparatus, such as a cell phone, using the embedded system 100.

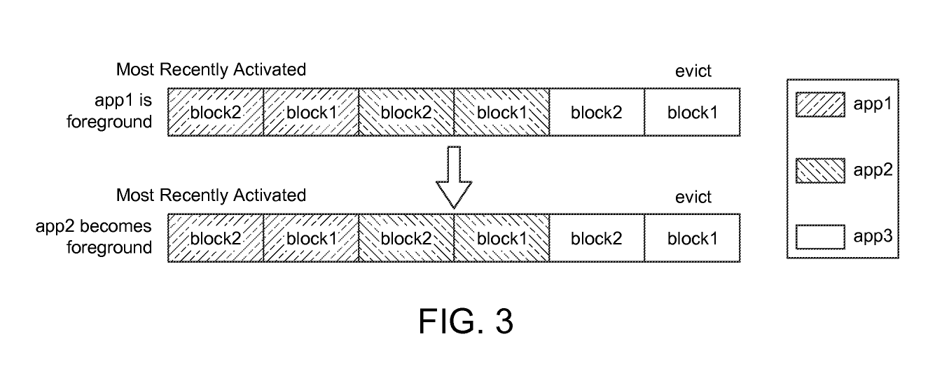

FIG. 3 is a diagram illustrating the decision-making process of the LRA policy in accordance with one embodiment of the present invention. In the present embodiment, for the sake of brevity, it is assume that the first-level cache memory 102a of the embedded system 100 merely has two blocks block1 and block2 used to store the I/O requests getting from three applications app1, app2 and app3. Each time when one of these I/O requests app1, app2 and app3 is accessed by the foreground apparatus the bock used to store the accessed I/O request may be put into a string and ranked in order of the priority that the I/O request is accessed. The first block within the ranking string is referred to as the most-recently activated (MRA) block; and the last one (i.e. the block1) is referred to as the least-recently activated (LRA) block that should be firstly written in to the second-level cache memory 102b and evicted from the first-level cache memory 102a.

Referring to FIG. 2 again, the cache operation of the embedded system 100 further includes steps of writing the dirty data (such as the dirty portion of the I/O request) stored in the dirty block 107B of the second-level cache memory 102b into the main storage device 101, and then evicting dirty block 107B of the second-level cache memory 102b. In some embodiments of the present invention, there are two ways for writing the dirty data stored in dirty block 107B of the second-level cache memory 102b into the main storage device 101. One is to apply the aforementioned replacement policy, such as the LRA policy, the CLOCK policy, the FCFS policy or the LRU policy, to write the dirty block 107B into the main storage device 101 (see the step 202). The other is to perform a background flush in according a flush command received from the controller 103 to write the all the dirty block 107B of the second-level cache memory 102b into the main storage device 101, and then evict all the dirty block 107B of the second-level cache memory 102b (see the step 203). Since the process of applying one of the replacement policies to write and evict a dirty block has been disclosed above the detailed steps thereof will not redundantly described here.

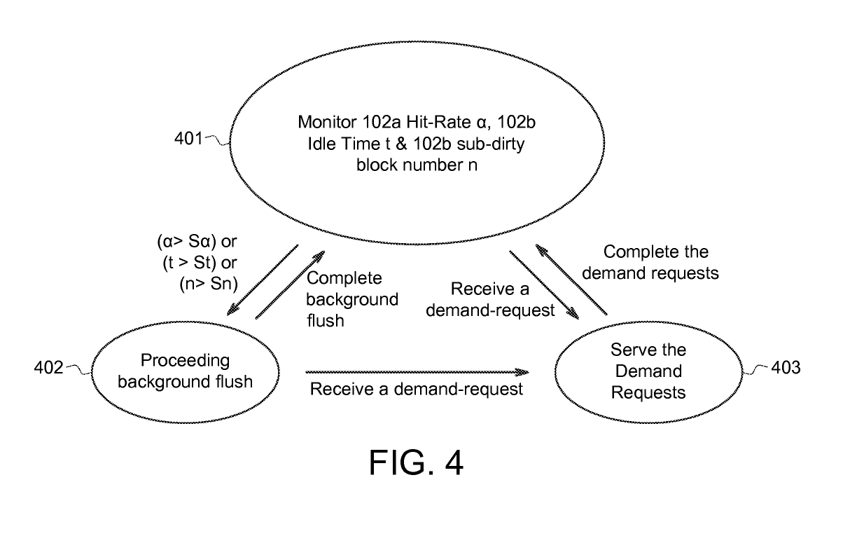

FIG. 4 is a diagram illustrating the process of background flush in accordance with one embodiment of the present invention. During the cache operation, the controller 103 may monitor the numbers n of the sub-dirty blocks existing in the second-level cache memory 102b, the hit rate α of the first-level cache memory 102a and the idle time t of the second-level cache memory 102b (see step 401). When one of the sub-dirty blocks numbers n, the hit rate α and the idle time t is greater than a predetermined standard (i.e. either n>Sₙ,α>S_{α} or t>St), the background flush process may be triggered to write all the dirty blocks 107B into the main storage device 101 and then evict all of the dirty blocks 107B of the second-level cache memory 102b (see step 402).

Typically, when either the sub-dirty blocks numbers n, the hit rate α or the idle time t is greater than a predetermined standard, the second-level cache memory 102b may be not busy and the dirty data stored in the second-level cache memory 102b is not accessed for a long time. Thus, writing the dirty data that is not accessed for a long time into the main storage device 101 by the not-busy second-level cache memory 102b may not increase the workload of the buffer cache device 102.

Of note that, the background flush may be suspended when the controller 103 receives a demand request to access the data stored in the second-level cache memory 102b. The process of monitoring the sub-dirty blocks numbers n, the hit rate α and the idle time t may be restarted after the demand request is served (see step 403).

Thereafter, the performance of the hybrid buffer cache device 102 provided by the embodiments of the present invention are compared with that of various traditional buffer cache devices. In one preferred embodiment, an Android smart phone is taken as a simulation platform to perform the comparison, wherein the simulation method includes steps as follows: A before-cache storage access traces including process ID, inode number, read/write/fsync/flush, I/O address, size, timestamp from a real Android smart phone while running real applications. These traces are then used on a trace-driven buffer cache simulator to implement simulations with different buffer cache architectures and management policies to generate an after-cache storage access traces. The generated traces are then used as the I/O workloads with the direct I/O access mode to the real Android smartphone to obtain the performance of the cache operation.

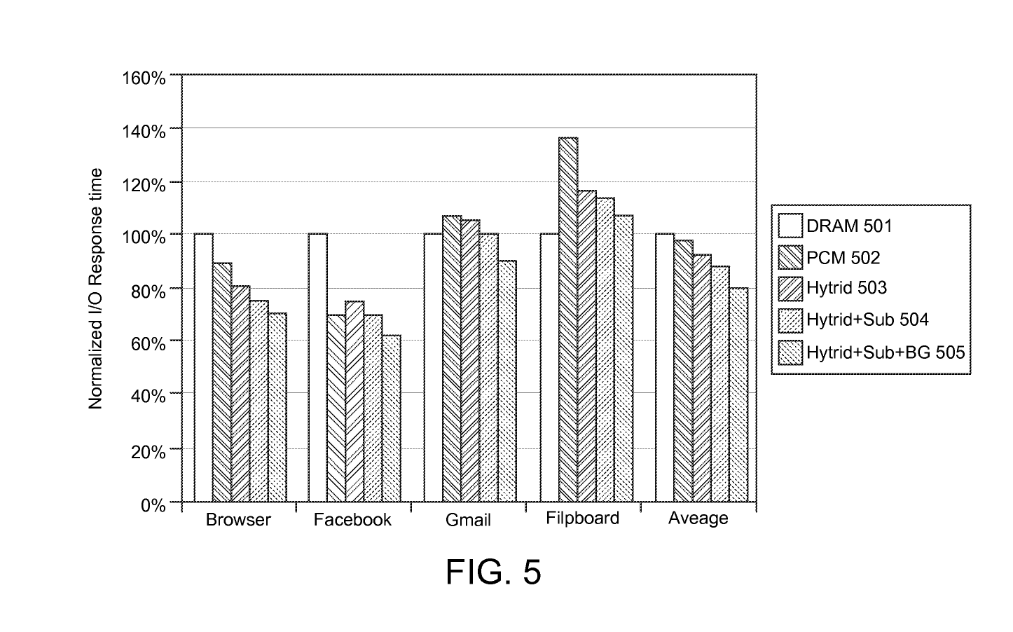

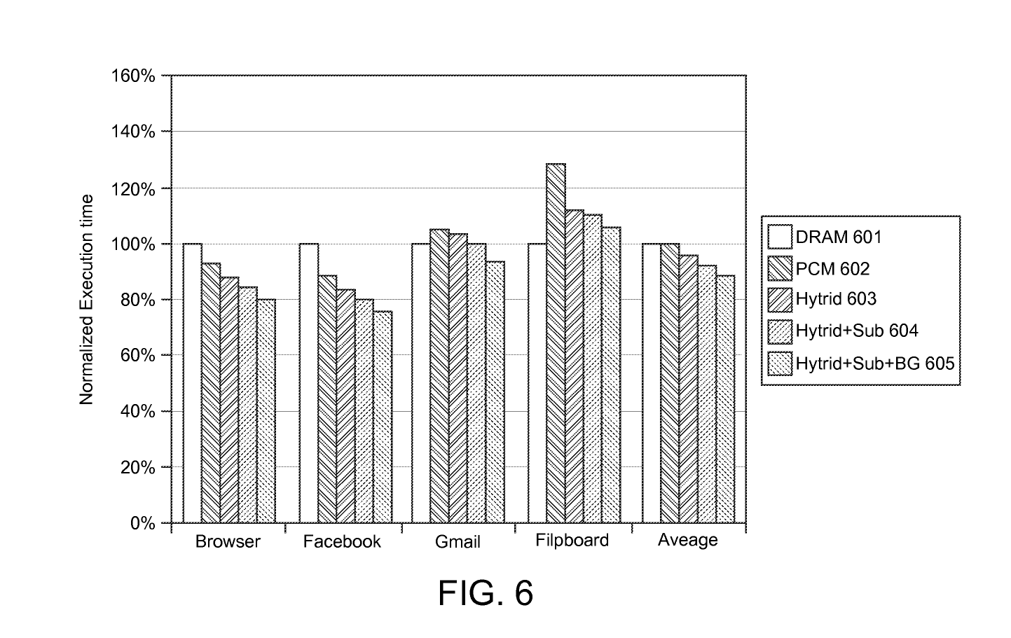

The simulation results are shown in FIGS. 5 and 6. FIG. 5 is a histogram illustrating the simulated I/O response time of the Android smart phone with different applications, various buffer cache architectures and management policies. There are 5 strip subsets are depicted in FIG. 5 respectively represent the simulation results and its average as 4 applications including Browser, Facebook, Gmail, Fliboard are applied to the Android smart phone. Each subset has 5 strips 501, 502, 503, 504 and 505 respectively represent the normalized I/O response times as the following buffer cache architectures and management policies including, a sole DRAM, PCM, the buffer cache device 102 provided by the aforementioned embodiment (designated as Hybrid), the present buffer cache device 102 further adapting the sub-dirty block management (designated as Hybrid+Sub) and the present buffer cache device 102 further adapting the sub-dirty block management as well as the background flush process (designated as Hybrid+Sub+BG), are applied as the sole cache storage media.

In the present embodiment, the I/O response times of the various buffer cache architectures are normalized to the buffer cache architecture applying DRAM as the sole cache storage media. In accordance with the simulation results shown in FIG. 5, it can be seen that the Android smart phone applying the buffer cache device 102 as the sole cache storage media (Hybrid) has about 7% normalized I/O response time shorter than that of the Android smart phone applying DRAM as the sole cache storage media. When the sub-dirty block management is further adopted by the present buffer cache device 102 (Hybrid+Sub) the normalized I/O response time can be reduced to about 13%. The Android smart phone that applies the buffer cache device 102 as the cache storage media and further adapts the sub-dirty block management and the background flush process (Hybrid+Sub+BG) may have about 23% normalized I/O response time shorter than that of the Android smart phone applying DRAM as the sole cache storage media. In sum, applying the buffer cache device 102 as the sole cache storage media can significant reduce the I/O response time of the cache operation.

FIG. 6 is a histogram illustrating the simulated application execution time of the Android smart phone with different applications, various buffer cache architectures and management policies. There are 5 strip subsets are depicted in FIG. 6 respectively represent the simulation results and its average as 4 applications including Browser, Facebook, Gmail, Fliboard are applied to the Android smart phone. Each subset has 5 strips 601, 602, 603, 604 and 505 respectively represent the normalized application execution times as the following buffer cache architectures and management policies including, a sole DRAM, PCM, the buffer cache device 102 provided by the aforementioned embodiment (designated as Hybrid), the present buffer cache device 102 further adapting the sub-dirty block management (designated as Hybrid+Sub) and the present buffer cache device 102 further adapting the sub-dirty block management as well as the background flush process (designated as Hybrid+Sub+BG), are applied as the sole cache storage media.

In the present embodiment, the I/O response times of the various buffer cache architectures are normalized to the buffer cache architecture applying DRAM as the sole cache storage media. In accordance with the simulation results shown in FIG. 5, it can be seen that the Android smart phone applying the buffer cache device 102 as the sole cache storage media (Hybrid) has about 7% normalized I/O response time shorter than that of the Android smart phone applying DRAM as the sole cache storage media. When the sub-dirty block management is further adopted by the present buffer cache device 102 (Hybrid+Sub) the normalized I/O response time can be reduced to about 13%. The Android smart phone that applies the buffer cache device 102 as the cache storage media and further adapts the sub-dirty block management and the background flush process (Hybrid+Sub+BG) may have about 23% normalized I/O response time shorter than that of the Android smart phone applying DRAM as the sole cache storage media. In sum, applying the buffer cache device 102 as the sole cache storage media can significant reduce the application execution time of the Android smart phone.

In accordance with the aforementioned embodiments of the present invention, a hybrid buffer cache device having a plurality multi-level cache memories and the applying system thereof are provided, wherein the hybrid buffer cache device at least includes a first-level cache memory and a second-level cache memory having a memory cell architecture different from that of the first-level cache memory. At least one data getting from at least one application can be firstly stored in the first-level cache memory, and a hierarchical write-back process is then performed to write the data stored in the first-level cache memory into the second-level cache memory. Such that, the problems of file system inconsistency in a prior buffer cache device using DRAM as the sole storage media can be solved.

In some embodiments of present invention, a sub-dirty block management is further introduced prior to the hierarchical write-back process and a background flush is performed during the hierarchical write-back process to enhance the write accesses of PCM involved in the hybrid buffer cache device, whereby the write latency due to the write power limitation of PCM can be also alleviated. In addition, the performance of the embedded system may be improved by applying a least-recently activated (LRA) data replacement policies to the buffer cache operation.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A buffer cache device used to get a first data from an application, comprising:
a first-level cache memory used to receive and store the first data;
a second-level cache memory having a memory cell architecture different from that of the first-level cache memory; and a
a controller used to write the first data stored in the first-level cache memory into the second-level cache memory.

2. The buffer cache device according to claim 1, wherein the first-level cache memory is a dynamic random access memory (DRAM), and the second-level cache memory is a phase change memory (PCM).

3. The buffer cache device according to claim 1, wherein the first-level cache memory comprises a plurality of blocks, and each of the blocks comprises:
a plurality of sub-blocks, each of which is used to store a portion of the first data;
a plurality of sub-dirty bits corresponding to one of the sub-blocks used to determine if there exists at least one dirty portion of the first data stored in the corresponding sub-blocks, and identify the sub-blocks that store the dirty portion of the first data as a sub-dirty block; and
a plurality of dirty bit used to determine if there exists the sub-dirty block in the corresponding block.

4. The buffer cache device according to claim 3, wherein each of the sub-blocks has a granularity substantially equal to the maximum bits the second-level cache memory can write at a time.

5. The buffer cache device according to claim 3, wherein the controller is used to monitor numbers of the sub-dirty block existing in the second-level cache memory, a hit rate of the first-level cache memory and an idle time of the second-level cache memory, and when one of the sub-dirty block numbers, the hit rate and the idle time is greater than a predetermined standard, all of the sub-dirty blocks stored in the second-level cache memory are written into a main storage device.

6. The buffer cache device according to claim 1, wherein the first-level cache memory is used to receive and store a second data, and the controller is used to choose either the first data or the second data stored in the first-level cache memory to be written into the second-level cache memory in accordance a Least-Recently-Activated (LRA) policy, a CLOCK policy, a First-Come First-Served (FCFS) policy or a Least-Recently-Used (LRU) policy, and the first data or the second data chosen by the controller is then evicted from the first-level cache memory to allow a third data stored therein.

7. The buffer cache device according to claim 6, wherein the LRA policy is used to choose the first data or the second data that is least-recently accessed by a foreground apparatus.

8. The buffer cache device according to claim 6, the controller is used to choose either the first data or the second data stored in the second-level cache memory to be written into a main storage device in accordance the LRA policy, the CLOCK policy, the FCFS policy or the LRU policy, and the first data or the second data chosen by the controller is then evicted from the second-level cache memory.

9. A method for managing a buffer cache device having a first-level cache memory and a second-level cache memory having a memory cell architecture different from that of the first-level cache memory, comprising:
getting a first data from a first application and storing the first data in the first-level cache memory; and
writing the first data stored in the first-level cache memory into the second-level cache memory.

10. The method according to claim 9, wherein the first-level cache memory is a DRAM, and the second-level cache memory is a PCM.

11. The method according to claim 9, further comprising:
dividing the first-level cache memory into a plurality of blocks, wherein each of the blocks comprises:
a plurality of sub-blocks, each of which is used to store a portion of the first data;
a plurality of sub-dirty bits corresponding to one of the sub-blocks used to determine if there exists at least one dirty portion of the first data stored in the corresponding sub-blocks, and identify the sub-blocks that store the dirty portion of the first data as a sub-dirty block; and
a plurality of dirty bit used to determine if there exists the sub-dirty block in the corresponding block.

12. The method according to claim 11, wherein the process of writing the first data stored in the first-level cache memory into the second-level cache memory comprises writing the dirty-sub block into the second-level cache memory.

13. The method according to claim 11, wherein each of the sub-blocks has a granularity substantially equal to the maximum bits the second-level cache memory can write at a time.

14. The method according to claim 11, further comprising:
monitoring numbers of the sub-dirty block existing in the second-level cache memory, a hit rate of the first-level cache memory and an idle time of the second-level cache memory; and
performing a background flush to write all of the sub-dirty blocks stored in the second-level cache memory into a main storage device, when one of the sub-dirty block numbers, the hit rate and the idle time is greater than a predetermined standard.

15. The method according to claim 14, further comprising:
stopping the background flush when receiving a demand request;
serving the demand request; and
monitoring the sub-dirty block numbers, the hit rate and the idle time.

16. The method according to claim 9, further comprising:
getting a second data from a second application and storing the second data in the first-level cache memory;
choosing either the first data or the second data stored in the first-level cache memory to be written into the second-level cache memory in accordance the LRA policy, the CLOCK policy, the FCFS policy or the LRU policy;
evicting the first data or the second data from the first-level cache memory; and
getting a third data from a third application and storing the third data in the first-level cache memory.

17. The method according to claim 16, wherein the LRA policy is used to choose the first data or the second data that is least-recently accessed by a foreground apparatus.

18. The method according to claim 16, further comprising:
choosing either the first data or the second data stored in the second-level cache memory to be written into a main storage device in accordance the LRA policy, the CLOCK policy, the FCFS policy or the LRU policy; and
evicting the first data or the second data from the second-level cache memory to allow the third data stored therein.

19. An embedded system, comprising:
a main storage device;
a buffer cache device, comprising:
a first-level cache memory used to receive at least one data from at least one application and to store the received data; and
a second-level cache memory having a memory cell architecture different from that of the first-level cache memory; and
a controller used to write the data stored in the first-level cache memory into the second-level cache memory, and to write the data stored in the second-level cache memory into the main storage device.

20. The embedded system according to claim 19, wherein the controller is built in the buffer cache device.
